(19) United States
(12) Patent Application Publication
(10) Pub. No.: US 2019/0339791 A1
(43) Pub. Date: Nov. 7, 2019

(54) FOOT CONTROLLER COMPUTER INPUT DEVICE

(71) Applicants: Jassim Alanajadah, Saginaw, MI (US); Markel Haralson, Dayton, OH (US)

(72) Inventors: Jassim Alanajadah, Saginaw, MI (US); Markel Haralson, Dayton, OH (US)

(21) Appl. No.: 15/972,315

(22) Filed: May 7, 2018

(51) Int. Cl. G06F 3/033; A63F 13/218; A63F 13/214; A63F 13/44; A63F 13/42; G02B 27/01

(52) U.S. Cl. CPC G06F 3/0334; A63F 13/218; A63F 13/214; A63F 2300/1068; A63F 13/42; G02B 27/017; A63F 13/44

(57) ABSTRACT

A foot controller for use with a computer having a graphics display. The foot controller includes a foot platform to sense actions of a user's feet, the foot platform including left and right foot pads. Each foot pad includes a toe sensor, a heel sensor, a left-side sensor, and a right-side sensor. Sensor circuits provide a stream of time-based measurements from each foot pad sensor. The foot controller includes a controller circuit to receive signals from each sensor circuit. The foot controller also includes a communication interface to transmit signals from the controller circuit to application software. The foot controller can use standard commands, and can easily be programmed to interface with many types of application software. The foot controller enables the user to use his/her feet to control a computer having a graphics display, thereby providing an addition to, or an alternative to, hand-based interactions with the application software.

### FIELD OF THE INVENTION

This invention relates generally to human-machine interfaces, and more particularly to computer input devices for use with application software.

### BACKGROUND OF THE INVENTION

The history of computing includes many different types of human-machine input devices. The earliest electronic computers typically used either a series of punched cards or punched tapes to input computer control data, with the punch media being programmed by a series of keystrokes on a keypunch machine with keys resembling typewriter keys. In the early 1960s, the first generation of electronic keyboards were introduced, typically with a QWERTY key layout for alpha-numeric data entry. At this time the first video display terminals which interacted directly with computer memory became available, and these terminals could display alpha-numeric characters on a phosphor screen as the corresponding keyboard keys were pressed, thereby eliminating the need for punched cards or punched tapes.

Shortly after the first electronic keyboards were introduced, arrow keys were added to the electronic keyboard to enable the movement of a cursor along the vertical and horizontal dimensions of the video display terminal. In the 1960s, trackballs were introduced to provide easy movement of the cursor on graphics displays by simply moving the user's fingers. In the late 1970s, the computer mouse was introduced, which made moving the cursor along the vertical and horizontal display dimensions as simple as moving the mouse vertically and horizontally along a flat surface next to the keyboard.

Also in the late 1970s, inexpensive joysticks that could be gripped by a user's hand were introduced for use with video game software. Joysticks are handheld directional transducers that can be tilted by hand so as to indicate direction over a 360 degree arc. Joysticks typically also provided fire-buttons to control objects on a graphics display, such as for controlling the firing of projectiles in video game software.

In 1982 the Amiga® Joyboard™ was introduced. The user stood on the Joyboard™ with both feet positioned around a pivot point located at the center of the Joyboard™, between the user's feet. The Joyboard™ therefore acted similarly to a joystick. Instead of sensing tilt caused by the users hand, the Joyboard™ sensed a leaning or tilting pressure from the stance of the user's feet, relative to the center of the Joyboard™. The Joyboard™ was a directional or angular transducer that translated the foot pressure balance for the pair of feet into a direction that was indicated by the angle or tilt of the pair of feet over a 360 degree arc. A disadvantage of the Amiga® Joyboard™ was that the directional angle was relative to both feet as a pair, but the Joyboard™ was not able to transduce the angular posture of each individual foot.

In the 1980s, the first video game hand controllers were introduced. Hand controllers typically include a small swiveling knob or button that gives the functionality of a joystick, but is capable of being controlled by only one finger. These hand controllers typically also include several buttons for fire control and other software control functions, including buttons that control the motion of objects on the graphics display.

In the late 1980s the first brain-wave computer interfaces were introduced which were typically worn on the user's head to detect brain wave patterns which could be used to control a graphics display, including controlling the motions of objects on a graphics display. However, the discomfort, inconvenience, cost, and difficulty of programming software applications to work with these brain-wave headsets resulted in only very limited sales and popularity.

In the 2000s, the first commercial whole-body computer interfaces were introduced, such as the Nintendo Wii®. With these interfaces, the motions of a user's limbs and body could be sensed in 3D, and the user's motions were used to control the motions of objects on a graphics display. However, the number of software programs that work with whole-body computer interfaces is limited due to their non-standard programming requirements, especially when compared to the much more popular video game hand controllers, which use a more standardized set of graphical instructions.

In 2007 the Nintendo Wii® Balance Board™ was introduced. This board is placed under a user's feet and has two pressure sensors per foot. However, having only two pressure sensors per foot limits the number of instructions that can be used with the Wii® Balance Board™.

While modern video game hand controllers remain very popular, hand controllers can cause fatigue to the fingers after more than one hour of use. Also, individuals with hand disabilities cannot effectively use a hand controller. In addition, the elderly often do not have the necessary hand coordination, and often lack fine finger muscle control, so they can have difficulty using a hand controller.

Another drawback of a hand controller occurs when using a hand controller during times of intense interaction with the graphics display, such as in high intensity computer gaming. The user may wish to perform other actions on the graphics display while the user's hands are completely occupied by controlling the hand controller.

An additional drawback can occur when a user is using a hand controller while wearing a virtual reality headset. Using a hand controller requires that the user's hands hold and manipulate the hand controller. However, while immersed in a virtual reality world, the user may need to do something else with their hands other than holding and manipulating the hand controller.

### SUMMARY OF THE INVENTION

The foot controller of the invention enables a user to control a graphics display, such as the graphics display of a video game, using his/her feet. Because the foot controller of the invention uses a standard set of commands, it can easily be programmed to interface with many types computer graphics software, such as with most video game software, as well as with software designed for use in various fields, including: education, medicine, factory floor automation, recreation, and computer controlled exercise equipment.

In addition, because the foot controller of the invention includes four sensors per foot pad, a more complex and detailed set of commands can be communicated to the graphics display than would be possible with fewer sensors per foot pad.

The foot controller of the invention can assume tasks that would otherwise need to be performed by the user's hands using a hand controller. Thus, using the foot controller instead of a hand controller can reduce hand fatigue.

Also, since it is natural for the user to use their feet when walking, running, and controlling the brake pedal and gas pedal of a car, using the foot controller of the invention can provide an intuitive and natural experience for the user when issuing motion commands in the graphical display environment.

Therefore, for many software applications, using the foot controller of the invention as an input device provides a more precisely controlled and intuitive interaction with the software application.

A general aspect of the invention is a foot controller for use with a computer having a graphics display. The foot controller includes: a foot platform configured to sense actions of a user's feet, the foot platform including a left foot pad and a right foot pad, each foot pad including: a toe sensor, a heel sensor, a left-side sensor, a right-side sensor, and a sensor circuit connected to each sensor, each sensor circuit providing a stream of time-based measurement signals; a controller circuit configured to receive the stream of time-based measurement signals from each sensor circuit, the controller circuit configured to produce movement signals; and a communication interface configured to receive the movement signals from the controller circuit, and then transmit the movement signals for use by application software running on the computer.

In some embodiments, time based measurement signals represent a sequence of time-based measurement states.

In some embodiments, the controller circuit and the communication interface are configured to produce movement signals to be transmitted to the computer, the movement signals including at least one of: a forward signal, a backward signal, a leftward signal, a rightward signal, a forward-leftward angular direction signal, a forward-rightward angular direction signal, a backward-leftward angular direction signal, a backward-rightward angular direction signal, a rotate right signal, and a rotate left signal.

In some embodiments, the controller circuit is configured to map combinations of signals representing actions of a user's feet to corresponding movement signals.

In some embodiments, the combinations of signals representing actions of a user's feet include at least one of: the left foot pad toe signal and the right foot pad toe signal, which are combined to produce the forward signal, the left foot pad heel signal and the right foot pad heel signal, which are combined to produce the backward signal, the left foot pad toe signal and the left foot pad heel signal, which are combined to produce the leftward signal, the right foot pad toe signal and the right foot pad heel signal, which are combined to produce the rightward signal, the left foot pad toe signal and the left foot pad heel signal and the right foot pad toe signal, which are combined to produce a left 45 degrees signal, the right foot pad toe signal and the right foot pad heel signal and the right foot pad toe signal, which are combined to produce a right 45 degrees signal, the left foot pad toe signal and the left foot pad heel signal and the right foot pad heel signal, which are combined to produce a left-back 45 degrees signal, the right foot pad toe signal and the right foot pad heel signal and the left foot pad heel signal, which are combined to produce a right-back 45 degrees signal, the left foot pad heel signal and the right foot pad toe signal, which are combined to produce the rotate left signal, and the left foot pad toe signal and the right foot pad heel signal, which are combined to produce the rotate right signal.

In some embodiments, the controller circuit and the communication interface are configured to produce movement signals which are transmitted to the computer having a graphics display, the movement signals including at least one of: a strafe-left signal and a strafe-right signal. In further embodiments, the controller circuit is configured to map combinations of signals representing actions of a user's feet, including at least one of: the left foot pad left-side signal and the right foot pad left-side signal, which are combined to produce the strafe-left signal, and the left foot pad right-side signal and the right foot pad right-side signal, which are combined to produce the strafe-right signal.

In some embodiments, the detection of an absence of a foot on any of the left foot pad sensors is encoded by the controller circuit so as to produce a jump signal. In some embodiments, the detection of an absence of a foot on any of the right foot pad sensors is encoded by the controller circuit so as to produce a crouch signal.

In some embodiments, the graphics display is a virtual reality headset.

In some embodiments, the communication interface transmits signal information received from the controller circuit to the graphics display using a wireless connection.

In some embodiments, the communication interface transmits signal information received from the controller circuit to the graphics display using a wired connection.

In some embodiments, the left foot pad sensor circuit and the right foot pad sensor circuit detect binary sensor values, and the controller circuit encodes the binary sensor values into binary output values, where the binary output values correspond to either a presence of motion or an absence of motion on the graphics display.

In some embodiments, the left foot pad sensor circuit and the right foot pad sensor circuit detect continuous sensor values, and the controller circuit encodes the continuous output values, where a magnitude of the continuous output values corresponds to a magnitude of a speed of motion on the graphics display.

### BRIEF DESCRIPTION OF THE DRAWINGS

Many additional features and advantages will become apparent to those skilled in the art upon reading the following description, when considered in conjunction with the accompanying drawings, wherein:

FIG. 1 is an isometric view showing the left foot and the right foot of a user standing on an embodiment of the foot controller, also using a graphics display, handheld controllers, and a virtual reality headset.

FIG. 2A is an isometric view of the foot controller, showing in dotted line the left foot of the user standing on the left foot pad of the foot controller, and the right foot of the user standing on the right foot pad of the foot controller.

FIG. 2B is an isometric view of the foot controller, showing the left foot pad and the right foot pad located on the upper portion of the foot controller, also showing the axes of foot motion detected by each foot pad.

FIG. 3A is a top view of the foot controller of FIGS. 2A and 2B, showing the left foot pad and the right foot pad on the upper portion of the foot controller, also showing the four foot sensors, with the toe sensors activated, corresponding to a forward signal.

FIG. 3B is a top view of the foot controller of FIGS. 2A and 2B, showing the left foot pad and the right foot pad on the upper portion of the foot controller, also showing the four foot sensors, with the heel sensors activated, corresponding to a backward signal.

FIG. 4 is a schematic diagram of the foot controller, showing the sensors, respective sensor circuits, and the signals provided to and received by a controller circuit, which is cooperative with a communication interface.

FIG. 5A is a side view showing the foot controller with a foot placed on a foot pad of the foot controller, also showing a toe sensor and a heel sensor, the toe sensor being activated.

FIG. 5B is a side view showing the foot controller with a foot placed on a foot pad of the foot controller, also showing a toe sensor and a heel sensor, the heel sensor being activated.

FIG. 6A is a rear view showing the foot controller with a left foot on the left foot pad and a right foot on the right foot pad of the foot controller, also showing the left-side sensors and the right-side sensors.

FIG. 6B is a rear view showing the foot controller with a left foot tilting leftward on the left foot pad and a right foot tilting leftward on the right foot pad of the foot controller, thereby activating the left-side sensor of each foot pad, corresponding to a strafe-left signal.

FIG. 6C is a rear view showing the foot controller with a left foot tilting rightward on the left foot pad, and a right foot tilting rightward on the right foot pad of the foot controller, thereby activating the right-side sensor of each foot pad, corresponding to a strafe-right signal.

FIG. 7A is a top view showing the left foot pad and a right foot pad of the foot controller, also showing four foot sensors.

FIG. 7B is a top view showing the left foot pad and a right foot pad of the foot controller, also showing four foot sensors, with the left-side sensors of each foot pad activated, corresponding to a strafe-left signal.

FIG. 7C is a top view showing the left foot pad and a right foot pad of the foot controller, also showing four foot sensors, with the right-side sensors of each foot pad activated, corresponding to a strafe-right signal.

FIG. 8A is a rear view showing the foot controller with the left foot in a raised position above the left foot pad, corresponding to a jump signal, also showing left-side sensors and right-side sensors for each foot pad.

FIG. 8B is a rear view showing the foot controller with the right foot in a raised position above the right foot pad, corresponding to a crouch signal, also showing the left-side sensors and the right-side sensors for each foot pad.

FIG. 9 is an exploded view showing the components of the foot controller, including the foot pads, the sensor aligners, the sensors, the mounting board, the sensor circuits, the controller circuit, and the communication interface.

FIG. 10A is a top view showing a left foot and a right foot, with each foot positioned over a toe sensor, a heel sensor, a left-side sensor, and a right-side sensor, the sensor activation pattern corresponding to a forward signal.

FIG. 10B is a top view showing a left foot and a right foot, with each foot positioned over a toe sensor, a heel sensor, a left-side sensor, and a right-side sensor, the sensor activation pattern corresponding to a backward signal.

FIG. 10C is a top view showing a left foot and a right foot, with each foot positioned over a toe sensor, a heel sensor, a left-side sensor, and a right-side sensor, the sensor activation pattern corresponding to a leftward signal.

FIG. 10D is a top view showing a left foot and a right foot, with each foot positioned over a toe sensor, a heel sensor, a left-side sensor, and a right-side sensor, the sensor activation pattern corresponding to a rightward signal.

FIG. 11A is a top view showing a left foot and a right foot, with each foot positioned over a toe sensor, a heel sensor, a left-side sensor, and a right-side sensor, the sensor activation pattern corresponding to a forward-leftward angular direction signal.

FIG. 11B is a top view showing a left foot and a right foot, with each foot positioned over a toe sensor, a heel sensor, a left-side sensor, and a right-side sensor, the sensor activation pattern corresponding to a forward-rightward angular direction signal.

FIG. 11C is a top view showing a left foot and a right foot, with each foot positioned over a toe sensor, a heel sensor, a left-side sensor, and a right-side sensor, the sensor activation pattern corresponding to a backward-leftward angular direction signal.

FIG. 11D is a top view showing a left foot and a right foot, with each foot positioned over a toe sensor, a heel sensor, a left-side sensor, and a right-side sensor, the sensor activation pattern corresponding to a backward-rightward angular direction signal.

FIG. 12A is a top view showing a left foot and a right foot, with each foot positioned over a toe sensor, a heel sensor, a left-side sensor, and a right-side sensor, the sensor activation pattern corresponding to a rotate left signal.

FIG. 12B is a top view showing a left foot and a right foot, with each foot positioned over a toe sensor, a heel sensor, a left-side sensor, and a right-side sensor, the sensor activation pattern corresponding to a rotate right signal.

FIG. 12C is a top view showing a left foot and a right foot, with each foot positioned over a toe sensor, a heel sensor, a left-side sensor, and a right-side sensor, the sensor activation pattern corresponding to a strafe-left signal.

FIG. 12D is a top view showing a left foot and a right foot, with each foot positioned over a toe sensor, a heel sensor, a left-side sensor, and a right-side sensor, the sensor activation pattern corresponding to a strafe-right signal.

### DETAILED DESCRIPTION

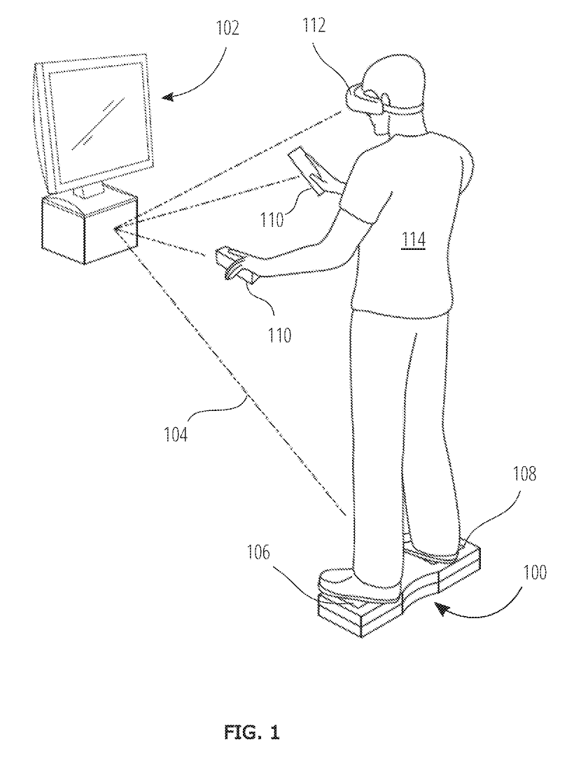

With reference to FIG. 1, a perspective view is shown of a user 114 with a left foot on a left foot pad 106 and a right foot on a right foot pad 108 of a foot controller 100.

In one embodiment, the foot controller 100 communicates with a computer having a graphics display 102 using a wireless connection 104.

In another embodiment, the user 114 controls the computer having the graphics display 102 with the foot controller 100.

In another embodiment, the user 114 controls the computer having the graphics display 102 with the foot controller 100 and at least one handheld control 110.

In another embodiment, the user 114 controls the virtual reality headset 112 using the foot controller 100.

In another embodiment, the user 114 controls the virtual reality headset 112 with the foot controller 100 and at least one handheld control 110.

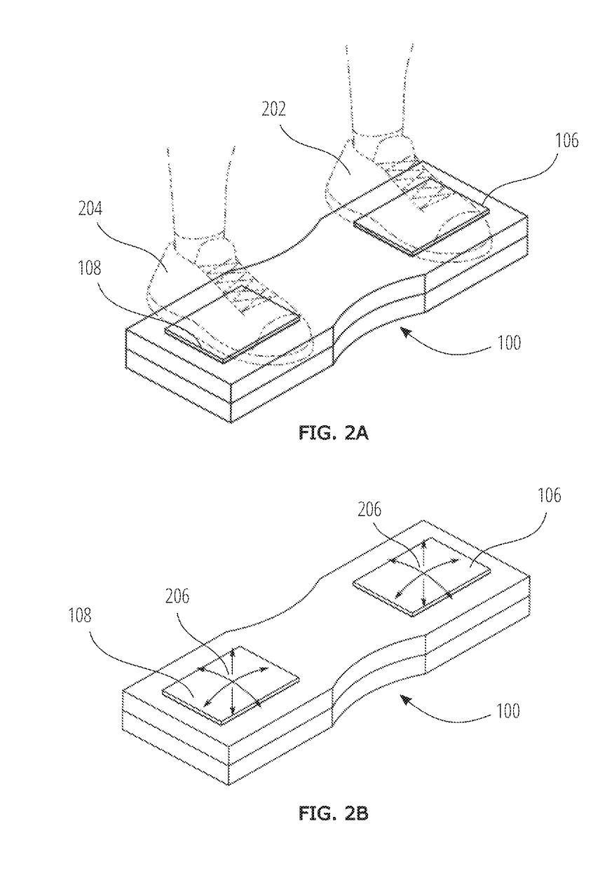

With reference to FIG. 2A, a perspective view is shown of the user 114 standing on the foot controller 100, with left foot 202 on the left foot pad 106 and right foot 204 on the right foot pad 108.

With reference to FIG. 2B, a perspective view is shown of the foot controller 100, having a left foot pad 106 and a right foot pad 108. The arrows above the left foot pad 106 and the right foot pad 108 show axes of foot motion 206 of the left foot 202 and the right foot 204. The axes of foot motion 206 of the user's feet on the left foot pad 106 and the right foot pad 108 include three mutually orthogonal axes: forward-backward, left-right, and vertical.

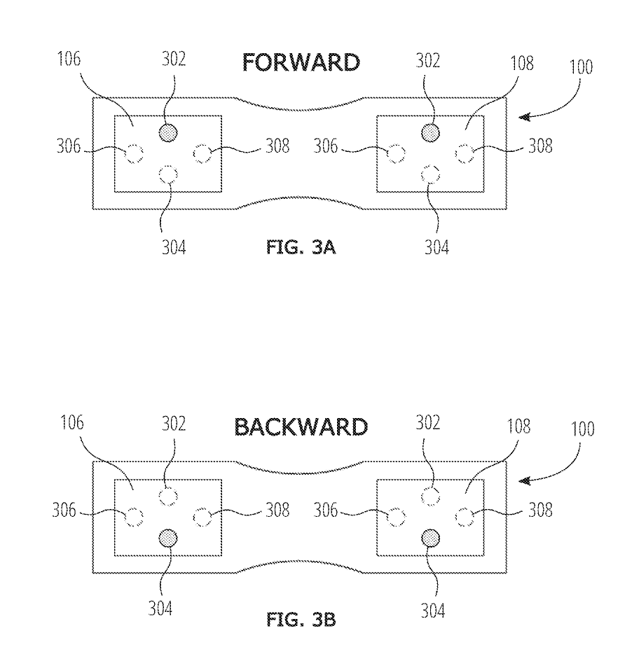

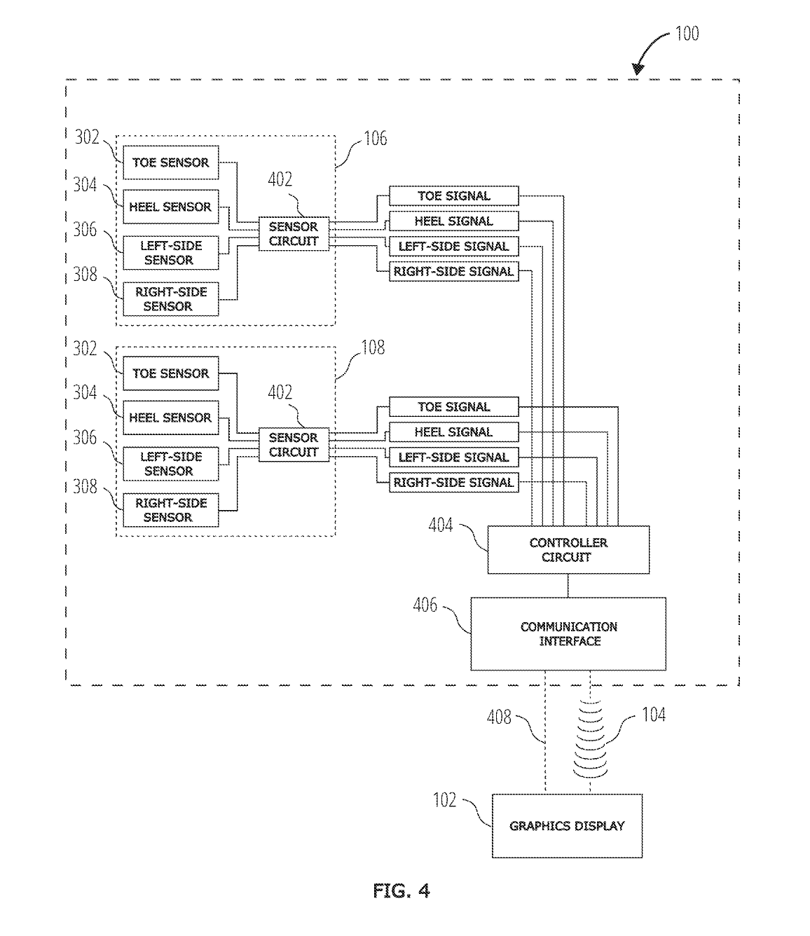

With reference to FIG. 3A, a top view is shown of a foot controller 100, having a left foot pad 106, and a right foot pad 108. Each foot pad includes a toe sensor 302, a heel sensor 304, a left-side sensor 306, and a right-side sensor 308. The left foot toe sensor 302 and the right foot toe sensor 302 are shown as activated, corresponding to a forward signal being generated by a controller circuit 404 (shown in FIG. 4).

With reference to FIG. 3B, a top view is shown of a foot controller 100, having a left foot pad 106, and a right foot pad 108. The left foot heel sensor 304 and the right foot heel sensor 304 are shown as activated, corresponding to a backward signal being generated by the controller circuit 404 (shown in FIG. 4).

With reference to FIG. 4, a schematic diagram is shown of the foot controller 100, including schematic diagrams of the left foot pad 106 and the right foot pad 108. Each foot pad 106, 108 includes a toe sensor 302, a heel sensor 304, a left-side sensor 306, a right-side sensor 308, and a sensor circuit 402. The sensor circuit 402 for the left foot pad 106 connects to a controller circuit 404, and the sensor circuit 402 for the right foot pad 108 also connects to the controller circuit 404.

The controller circuit 404 outputs a toe signal, a heel signal, a left-side signal, and a right-side signal which all feed into a communication interface 406.

The left foot pad 106 sensor circuit 402 outputs a toe signal, a heel signal, a left-side signal, and a right-side signal, which all feed into the communication interface 406. The right foot pad 108 sensor circuit 402 also outputs a toe signal, a heel signal, a left-side signal, and a right-side signal, which all feed into the communication interface 406.

In one embodiment, the communication interface 406 transmits data to the computer having a graphics display 102 via a wireless connection 104.

In another embodiment, the communication interface 406 transmits data to the computer having a graphics display 102 via a wired connection 408.

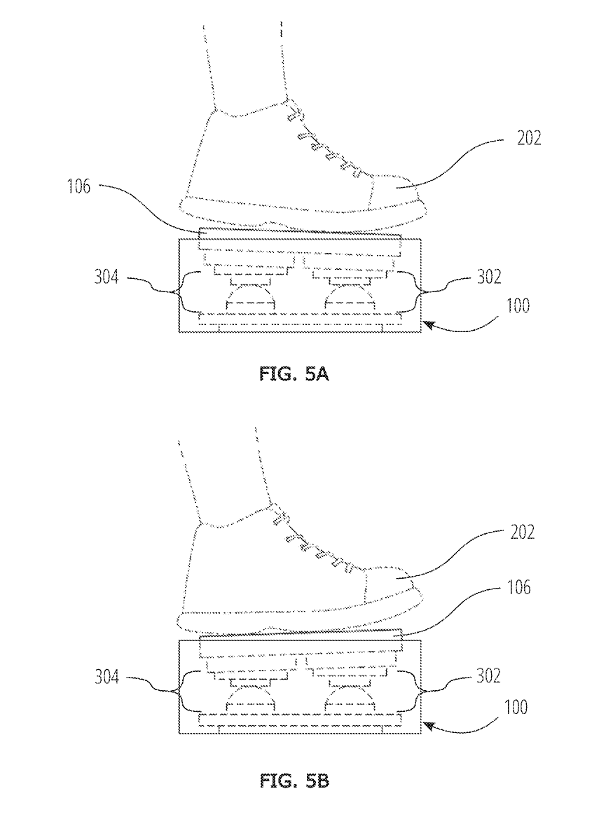

With reference to FIG. 5A, a side view is shown of a left foot 202 on the left foot pad 106 of the foot controller 100, showing the toe sensor 302 and the heel sensor 304, the toe sensor 302 being activated by the user 114 (shown in FIG. 1) pressing the toe of the left foot 202 downward.

With reference to FIG. 5B, a side view is shown of a left foot 202 on a left foot pad 106 of the foot controller 100, showing the toe sensor 302 and the heel sensor 304, the heel sensor 304 being activated by the user 114 (shown in FIG. 1) pressing the heel of the left foot 202 downward.

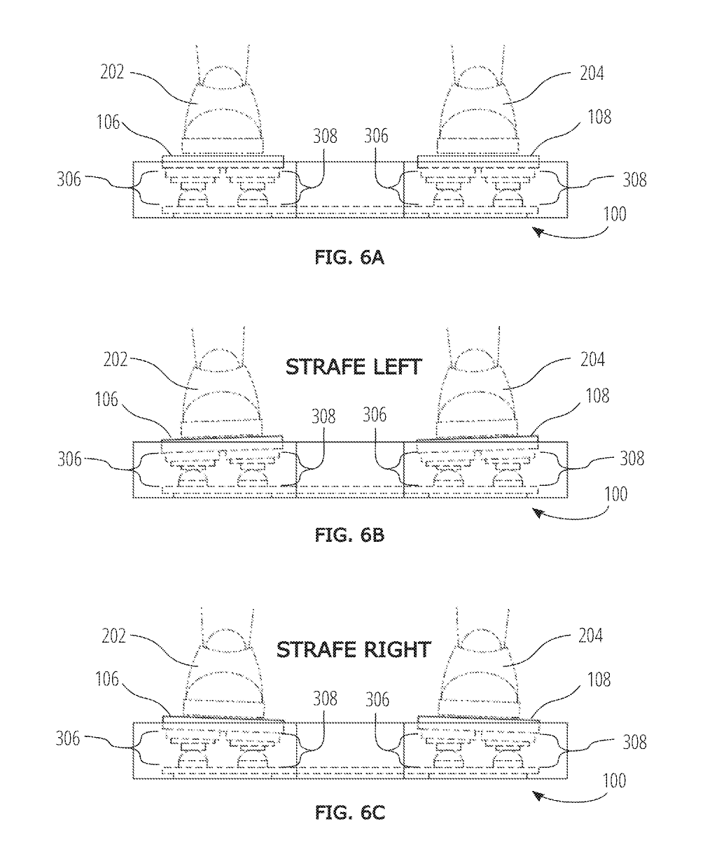

With reference to FIG. 6A, a rear view is shown of the foot controller 100 with the left foot 202 on the left foot pad 106, and the right foot 204 on the right foot pad 108, also showing the left-side sensor 306 and the right-side sensor 308 under each foot pad.

With reference to FIG. 6B, a rear view is shown of the foot controller 100 with the left foot 202 tilting leftward on the left foot pad 106, and the right foot 204 tilting leftward on the right foot pad 108. Consequently, the left foot pad 106 and the right foot pad 108 each tilt leftward, thereby activating the left-side sensor 306 of each foot pad, corresponding to a strafe-left signal being generated by a controller circuit 404 (shown in FIG. 4).

With reference to FIG. 6C, a rear view is shown of a foot controller 100 with the left foot 202 tilting rightward on the left foot pad 106, and the right foot 204 tilting rightward on the right foot pad 108. Consequently, the left foot pad 106 and the right foot pad 108 each tilt rightward, thereby activating the right-side sensor 308 of each foot pad, corresponding to a strafe-right signal being generated by a controller circuit 404 (shown in FIG. 4).

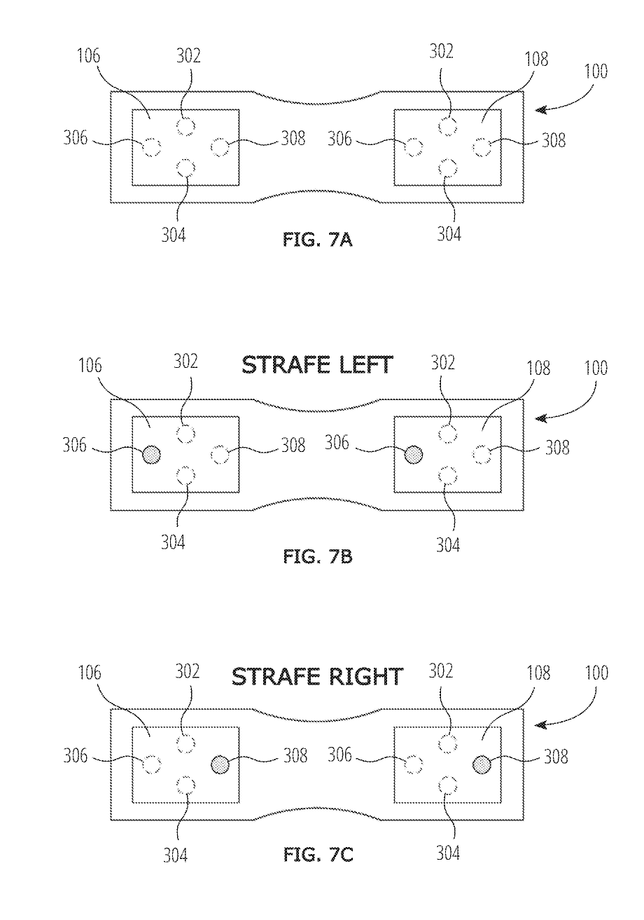

With reference to FIG. 7A, a top view is shown of the foot controller 100, having a left foot pad 106, and a right foot pad 108. Each foot pad includes a toe sensor 302, a heel sensor 304, a left-side sensor 306, and a right-side sensor 308. None of the sensors are activated, corresponding to no signal being generated by the controller circuit 404 of FIG. 4.

With reference to FIG. 7B, a top view is shown of a foot controller 100, having a left foot pad 106, and a right foot pad 108. The left-side sensor 306 of each foot pad 106, 108 is shown as being activated, corresponding to a strafe-left signal being generated by the controller circuit 404 of FIG. 4.

With reference to FIG. 7C, a top view is shown of a foot controller 100, having a left foot pad 106, and a right foot pad 108. The right-side sensor 308 of each foot pad 106, 108 is shown as being activated, corresponding to a strafe-right signal being generated by the controller circuit 404 of FIG. 4.

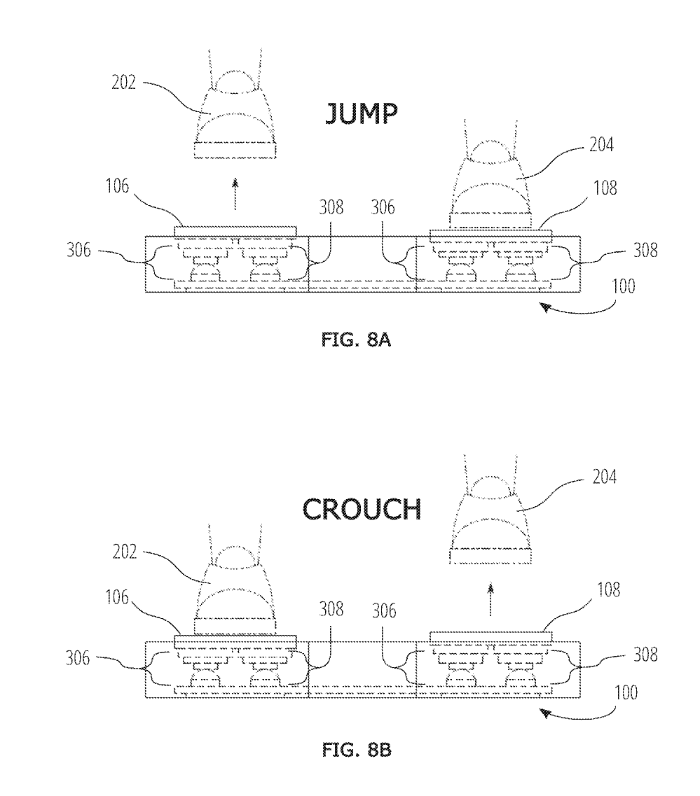

With reference to FIG. 8A, a rear view is shown of the foot controller 100 with a left foot 202 in a raised position above the left foot pad 106, and a right foot 204 pressing on the right foot pad 108, corresponding to a jump signal being generated by a controller circuit 404 of FIG. 4, and also showing a left-side sensor 306 and a right-side sensor 308 under each foot pad.

With reference to FIG. 8B, a rear view is shown of the foot controller 100 with the left foot 202 pressing on the left foot pad 106, and the right foot 204 in a raised position above the right foot pad 108, corresponding to a crouch signal being generated by the controller circuit 404 of FIG. 4, and also showing the left-side sensor 306 and the right-side sensor 308 under each foot pad.

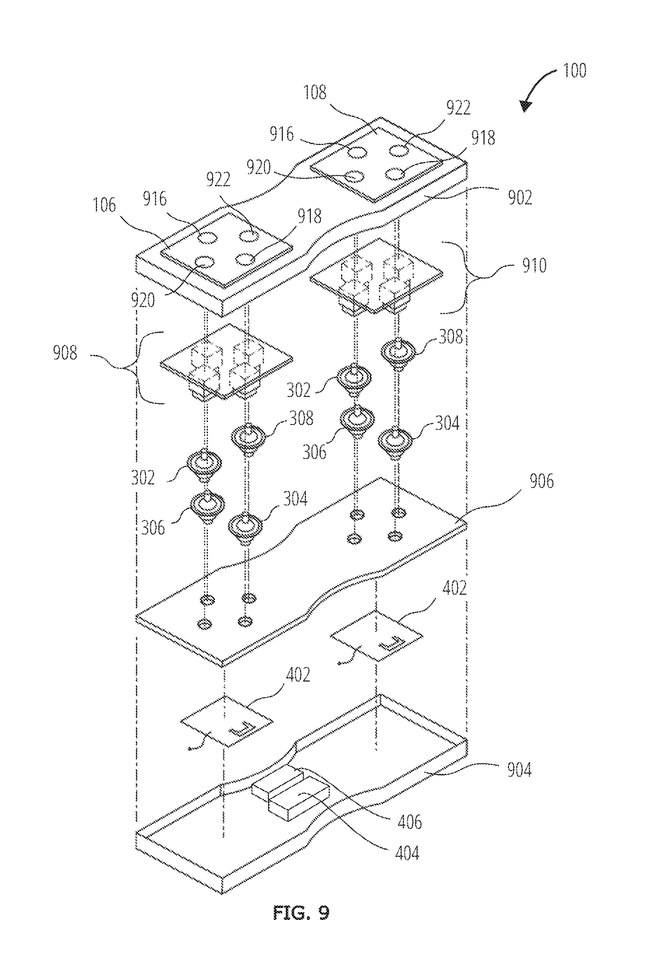

With reference to FIG. 9, an exploded view is shown of the foot controller 100, showing the left foot pad 106, and the right foot pad 108, each foot pad 106, 108 including a toe sensor pad 916, a heel sensor pad 918, a left-side sensor pad 920, and a right-side sensor pad 922.

In this embodiment, below a foot controller cover 902 are four left sensor aligners 908 and four right sensor aligners 910. Below the sensor aligners 908, 910 are four sensors for each foot, including: a toe sensor 302, a heel sensor 304, a left-side sensor 306, and a right-side sensor 308. The sensors 302, 304, 306, 308 are mounted into a foot controller mounting board 906. Below the foot controller mounting board 906 is a sensor circuit 402 for the left foot pad 106 and the sensor circuit 402 for the right foot pad 108, each providing a stream of time-based measurement data from each sensor. The sensor measurement data is transmitted to the controller circuit 404, which emits direction signals to the communication interface 406, which communicates with the graphics display 102 of FIG. 1.

A foot controller base 904 encloses and supports the bottom of the foot controller 100.

In some embodiments, the communication interface 406 transmits the signals information from the controller circuit 404 to the graphics display 102 of FIG. 1 using a wireless connection 104 (as shown in FIG. 1).

In some embodiments, the communication interface 406 transmits the signals information from the controller circuit 404 to the graphics display 102 of FIG. 1 using a wired connection 408 (shown in FIG. 4), such as via an electrical cord.

In some embodiments, the left foot pad 106 and respective sensor circuit 402, and the right foot pad 108 and respective sensor circuit 402 sense binary digital sensor values, and the controller circuit 404 encodes the binary sensor values into binary output values, where the binary output values correspond to either a presence of motion or an absence of motion on the graphics display 102 of FIG. 1.

In some embodiments, the left foot pad 106 and respective sensor circuit 402, and the right foot pad 108 and respective sensor circuit 402 sense continuous analog sensor values, and the controller circuit 404 encodes continuous output values, where the magnitude of the continuous output values corresponds to the magnitude of the speed of the motion on the graphics display 102 of FIG. 1.

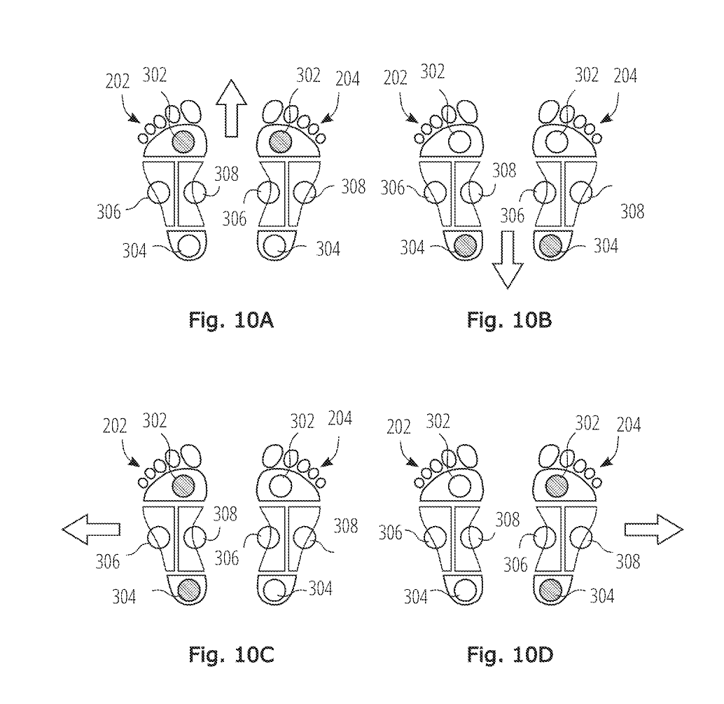

With reference to FIGS. 10A, 10B, 10C, and 10D, a top view is shown of a left foot 202 and a right foot 204, with each foot positioned over a toe sensor 302, a heel sensor 304, a left-side sensor 306, and a right-side sensor 308.

With reference to FIG. 10A, a sensor activation pattern is shown wherein the left foot toe sensor 302 is activated and the right foot toe sensor 302 activated, the sensor activation pattern corresponding to a forward signal being generated by the controller circuit 404 of FIG. 4.

With reference to FIG. 10B, a sensor activation pattern is shown wherein the left foot heel sensor 304 is activated and the right foot heel sensor 304 is activated, the sensor activation pattern corresponding to a backward signal being generated by the controller circuit 404 of FIG. 4.

With reference to FIG. 10C, a sensor activation pattern is shown wherein the left foot toe sensor 302 and the left foot heel sensor 304 are activated and no right foot sensors activated, the sensor activation pattern corresponding to a leftward signal being generated by the controller circuit 404 of FIG. 4.

With reference to FIG. 10D, a sensor activation pattern is shown wherein no left foot sensors are activated, and the right foot toe sensor 302 and the right foot heel sensor 304 are activated, the sensor activation pattern corresponding to a rightward signal being generated by the controller circuit 404 of FIG. 4.

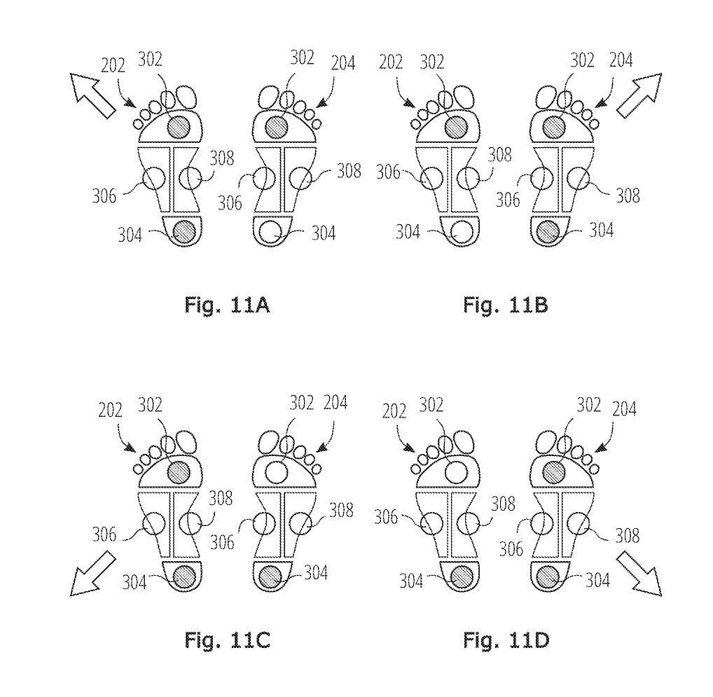

With reference to FIGS. 11A, 11B, 11C, and 11D, a top view is shown of a left foot 202 and a right foot 204, with each foot positioned over a toe sensor 302, a heel sensor 304, a left-side sensor 306, and a right-side sensor 308.

With reference to FIG. 11A, a sensor activation pattern is shown wherein the left foot toe sensor 302 and left foot heel sensor 304 are activated and the right foot toe sensor 302 is activated, the sensor activation pattern corresponding to a forward-leftward angular direction signal being generated by a controller circuit 404 of FIG. 4.

With reference to FIG. 11 B, a sensor activation pattern is shown wherein the left foot toe sensor 302 is activated and the right foot toe sensor 302 and the right foot heel sensor 304 are activated, the sensor activation pattern corresponding to a forward-rightward angular direction signal being generated by the controller circuit 404 of FIG. 4.

With reference to FIG. 11C, a sensor activation pattern is shown wherein the left foot toe sensor 302 and the left foot heel sensor 304 activated and the right foot heel sensor 304 is activated, the sensor activation pattern corresponding to a backward-leftward angular direction signal being generated by the controller circuit 404 of FIG. 4.

With reference to FIG. 11 D, a sensor activation pattern is shown wherein the left foot heel sensor 304 activated and the right foot toe sensor 302 and the right foot heel sensor 304 is activated, the sensor activation pattern corresponding to a backward-rightward angular direction signal being generated by the controller circuit 404 of FIG. 4.

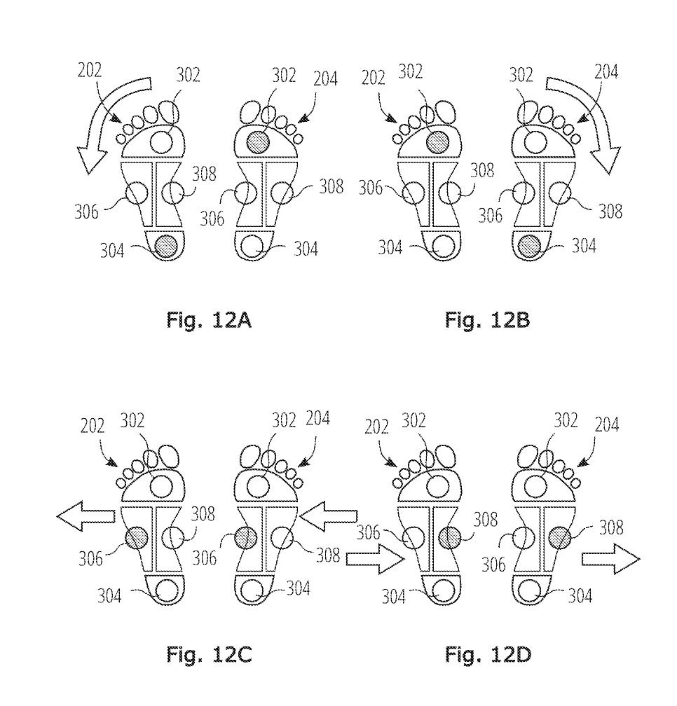

With reference to FIGS. 12A, 12B, 12C, and 12D, a top view is shown of a left foot 202 and a right foot 204, with each foot positioned over a toe sensor 302, a heel sensor 304, a left-side sensor 306, and a right-side sensor 308.

With reference to FIG. 12A, a sensor activation pattern is shown wherein the left foot heel sensor 304 is activated and the right foot toe sensor 302 is activated, the sensor activation pattern corresponding to a rotate left signal being generated by a controller circuit 404 of FIG. 4.

With reference to FIG. 12B, a sensor activation pattern is shown wherein the left foot toe sensor 302 is activated and the right foot heel sensor 304 is activated, the sensor activation pattern corresponding to a rotate right signal being generated by a controller circuit 404 of FIG. 4.

With reference to FIG. 12C, a sensor activation pattern is shown wherein the left foot left-side sensor 306 is activated and the right foot left-side sensor 306 is activated, the sensor activation pattern corresponding to a strafe-left signal being generated by a controller circuit 404 of FIG. 4.

With reference to FIG. 12D, a sensor activation pattern is shown wherein the left foot right-side sensor 308 is activated and the right foot right-side sensor 308 is activated, the sensor activation pattern corresponding to a strafe-right signal being generated by a controller circuit 404 of FIG. 4.

Other modifications and implementations will occur to those skilled in the art without departing from the spirit and the scope of the invention as claimed. Accordingly, the above description is not intended to limit the invention, except as indicated in the following claims.

What is claimed is:

1. A foot controller for use with a computer having a graphics display, the foot controller comprising:
a foot platform configured to sense actions of a user's feet, the foot platform including a left foot pad and a right foot pad, each foot pad including: a toe sensor, a heel sensor, a left-side sensor, a right-side sensor, and a sensor circuit connected to each sensor, each sensor circuit providing a stream of time-based measurement signals;
a controller circuit configured to receive the stream of time-based measurement signals from each sensor circuit, the controller circuit configured to produce movement signals; and
a communication interface configured to receive the movement signals from the controller circuit, and then transmit the movement signals for use by application software running on the computer.

2. The foot controller of claim 1, wherein the time based measurement signals represent a sequence of time-based measurement states.

3. The foot controller of claim 1, wherein the controller circuit and the communication interface are configured to produce movement signals to be transmitted to the computer, the movement signals including at least one of:
a forward signal, a backward signal, a leftward signal, a rightward signal, a forward-leftward angular direction signal, a forward-rightward angular direction signal, a backward-leftward angular direction signal, a backward-rightward angular direction signal, a rotate right signal, and a rotate left signal.

4. The foot controller of claim 1, wherein the controller circuit is configured to map combinations of signals representing actions of a user's feet to corresponding movement signals.

5. The foot controller of claim 4, wherein the combinations of signals representing actions of a user's feet include at least one of:
the left foot pad toe signal and the right foot pad toe signal, which are combined to produce the forward signal,
the left foot pad heel signal and the right foot pad heel signal, which are combined to produce the backward signal,
the left foot pad toe signal and the left foot pad heel signal, which are combined to produce the leftward signal,
the right foot pad toe signal and the right foot pad heel signal, which are combined to produce the rightward signal,
the left foot pad toe signal and the left foot pad heel signal and the right foot pad toe signal, which are combined to produce a left 45 degrees signal,
the right foot pad toe signal and the right foot pad heel signal and the right foot pad toe signal, which are combined to produce a right 45 degrees signal,
the left foot pad toe signal and the left foot pad heel signal and the right foot pad heel signal, which are combined to produce a left-back 45 degrees signal,
the right foot pad toe signal and the right foot pad heel signal and the left foot pad heel signal, which are combined to produce a right-back 45 degrees signal,
the left foot pad heel signal and the right foot pad toe signal, which are combined to produce the rotate left signal, and
the left foot pad toe signal and the right foot pad heel signal, which are combined to produce the rotate right signal.

6. The foot controller of claim 1, wherein the controller circuit and the communication interface are configured to produce movement signals which are transmitted to the computer having a graphics display, the movement signals including at least one of:
a strafe-left signal and a strafe-right signal.

7. The foot controller of claim 6, wherein the controller circuit is configured to map combinations of signals representing actions of a user's feet, including at least one of:
the left foot pad left-side signal and the right foot pad left-side signal, which are combined to produce the strafe-left signal, and
the left foot pad right-side signal and the right foot pad right-side signal, which are combined to produce the strafe-right signal.

8. The foot controller of claim 1, wherein the detection of an absence of a foot on any of the left foot pad sensors is encoded by the controller circuit so as to produce a jump signal.

9. The foot controller of claim 1, wherein the detection of an absence of a foot on any of the right foot pad sensors is encoded by the controller circuit so as to produce a crouch signal.

10. The foot controller of claim 1, wherein the graphics display is a virtual reality headset.

11. The foot controller of claim 1, wherein the communication interface transmits signal information received from the controller circuit to the graphics display using a wireless connection.

12. The foot controller of claim 1, wherein the communication interface transmits signal information received from the controller circuit to the graphics display using a wired connection.

13. The foot controller of claim 1, wherein the left foot pad sensor circuit and the right foot pad sensor circuit detect binary sensor values, and the controller circuit encodes the binary sensor values into binary output values, where the binary output values correspond to either a presence of motion or an absence of motion on the graphics display.

14. The foot controller of claim 1, wherein the left foot pad sensor circuit and the right foot pad sensor circuit detect continuous sensor values, and the controller circuit encodes the continuous output values, where a magnitude of the continuous output values corresponds to a magnitude of a speed of motion on the graphics display.
